(19) United States
(12) Patent Application Publication
(10) Pub. No.: US 2026/0196745 A1
(43) Pub. Date: Jul. 9, 2026

(54) RADIAL LEVER CONNECTOR

(71) Applicant: Panduit Corp., Tinley Park, IL (US)

(72) Inventor: Philip W. Seils, Chicago, IL (US)

(73) Assignee: Panduit Corp., Tinley Park, IL (US)

(21) Appl. No.: 19/400,563

(22) Filed: Nov. 25, 2025

Related U.S. Application Data
(60) Provisional application No. 63/742,493, filed on Jan. 7, 2025.

(51) Int. Cl. H01R 4/48

(52) U.S. Cl. CPC H01R 4/48

(57) ABSTRACT

A radial lever connector is disclosed that includes a plurality of lever connectors centered around a central bus bridge conductor. Each of the lever connectors includes a corresponding wire channel for inserting a wire conductor, where the wire channels lead towards the central bus bridge conductor, so that all wire conductors that are inserted into their respective wire channel may be electrically coupled to each other via connection with the central bus bridge conductor.

### CROSS-REFERENCE TO RELATED APPLICATIONS

This application claims benefit to U.S. Provisional Patent Application No. 63/742,493, filed January 7, 2025, the entirety of which is hereby incorporated by reference herein.

### FIELD OF TECHNOLOGY

This disclosure relates to a radial lever connector for bridging multiple conductor wires together around a common conductor.

### BACKGROUND

Lever connectors are increasing in popularity as the preferred alternative to the traditional twist on wire nut solution for coupling conductor wires together because the lever wire connectors are touted as providing a quick and easy installation process while also ensuring a secure and consistent electrical connection. However, despite the touted benefits, the current offering of lever wire connectors are typically designed into a linear patterns of 2, 3, and 5 wires, which lack certain optimizations.

For example, these designs may be effective but fail to efficiently use the 3D space they occupy, especially with the larger connectors (5-wire). These linear style of lever connectors can be up to 0.75 of an inch in length for the 3-wire design and 1.25 of an inch for the 5-wire design in length, which occupies a much larger footprint than the traditional wire nut that can hold the same number of wires. So, the larger footprint of these linear style lever connectors can pose a problem in limited space applications such as inside enclosure boxes, behind an outlet or light switch in a junction box, in a junction box with multiple circuits passing through, in a junction box with a limited access to manipulate the wires inside, or other similar space constricted applications.

### SUMMARY

This disclosure relates to a radial style lever connector design that makes more efficient uses of its 3D space when compared to the existing linear style lever connectors occupy.

According to an embodiment, a radial lever connector is provided. The radial lever connector includes a housing body comprising at least a first lever, a second lever, a third lever, and a center portion housing a bus bridge conductor, wherein the first lever, the second lever, and the third lever are centered around the center portion and correspond to their own respective lever connector component.

According to an embodiment, a radial lever connector is provided, where the radial lever connector includes a housing body comprising: a first lever connector including a first lever and a first opening configured to receive a first conductor, a second lever connector including a second lever and a second opening configured to receive a second conductor, a third lever connector including a third lever and a third opening configured to receive a third conductor, and a center portion housing a bus bridge conductor, wherein the first lever connector, the second lever connector, and the third lever are centered around the center portion.

### BRIEF DESCRIPTION OF THE DRAWINGS

FIG. 1 is a perspective view of an exemplary 3-wire radial lever connector, according to an embodiment of this disclosure.

FIG. 2 is front-side view of the 3-wire radial lever connector shown in FIG. 1.

FIG. 3 is a rear-side view of the 3-wire radial lever connector shown in FIG. 1, according to an embodiment of this disclosure.

FIG. 4 is a perspective view of a 5-wire radial lever connector, according to an embodiment of this disclosure.

FIG. 5 is front-side view of the 5-wire radial lever connector shown in FIG. 4.

FIG. 6 is a rear-side view of the 5-wire radial lever connector shown in FIG. 4, according to an embodiment of this disclosure.

FIG. 7 is a cross-sectional view of the 3-wire radial lever connector taken along the line 7-7 shown in FIG. 2, according to an embodiment of this disclosure.

FIG. 8 is a rear-side view of the 3-wire radial lever connector shown in FIG. 1, where a rear cover has been removed to provide a view into internal components of the 3-wire radial lever connector, according to an embodiment of this disclosure.

FIG. 9A is a perspective view of a bus bridge conductor that may be used in the radial lever connectors, according to an embodiment of this disclosure.

FIG. 9B is a perspective view of an alternative bus bridge conductor that may be used in the radial lever connectors, according to an alternative embodiment of this disclosure.

FIG. 9C is a perspective view of an alternative bus bridge conductor that may be used in the radial lever connectors, according to an alternative embodiment of this disclosure.

FIG. 10 is a perspective view of a contoured clamping spring for including in a radial lever connector, according to an embodiment of this disclosure.

FIG. 11 is a sectional view of a radial lever connector including the contoured clamping spring shown in FIG. 10, according to an embodiment of this disclosure.

FIG. 12 is a rear-side view of the radial lever connector shown in FIG. 11, where a rear cover has been removed and the contoured clamping spring is in a disengaged position, according to an embodiment of this disclosure.

FIG. 13 is a rear-side view of the radial lever connector shown in FIG. 11, where a rear cover has been removed and where the contoured clamping spring is in an engaged position, according to an embodiment of this disclosure.

FIG. 14 is a perspective view of an alternative contoured leg springs for including in a radial lever connector, according to an embodiment of this disclosure.

FIG. 15 is a sectional view of a radial lever connector including the contoured leg springs shown in FIG. 14, according to an embodiment of this disclosure.

FIG. 16 is a sectional view from a rear-side of the radial lever connector shown in FIG. 15, where the contoured leg springs is in a disengaged position, according to an embodiment of this disclosure.

FIG. 17 is a sectional view from a rear-side of the radial lever connector shown in FIG. 15, where the contoured leg springs is in an engaged position, according to an embodiment of this disclosure.

### DETAILED DESCRIPTION

This disclosure relates to a radial lever connector where wires are inserted into wire channels around a central bus bridge conductor, according to various embodiments. The radial lever connectors are configured to internally hold a bus bridge conductor within a central location and radially surround the bus bridge conductor with wire channels for receiving wire conductors. This design configuration enables any wire conductor installed into a wire channel to be electrically coupled via the centrally located bus bridge conductor, where the contact between the wire conductors and the bus bridge conductor is achieved across a larger surface area, which may reduce the likelihood of resistance heating, among other enhancements compared to the existing types of linear lever connectors.

Another drawback to the current bus bar designs in the linear lever conductors is how the conductor is seated when the clamping spring clamps down on the conductor to be forced into contact with the bus bar. The clamp and bus bar have the tendency to pinch and gouge the conductor creating a reduced contact surface area via the gouge marks. The clamping spring also has the tendency to push the conductor towards a single contact point rather than along the designed contact surface area. This gouging and improper seating could create the potential for resistance heating when under a sustained load as mentioned in the background above. To prevent this tendency the bus bridge conductor design in the present radial lever conductors incorporates some features to create a larger contact surface area to alleviate these concerns.

For exemplary purposes, this disclosure describe both a 3-wire radial lever connector and a 5-wire radial lever connector, although other alternative embodiments that are configured to accept and bridge different number of wires are also within the scope of the radial lever connector described herein.

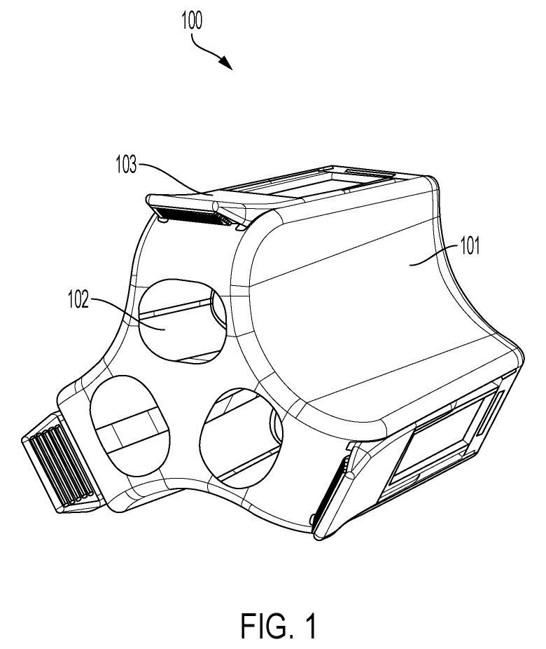

FIG. 1 shows a perspective view of a 3-wire radial lever connector 100 according to an embodiment of this disclosure. The radial lever connector 100 includes a body housing that includes a number of recesses 101 corresponding to, for example, the number of wire channels 102 for receiving individual wire conductors. The recesses 101 provide a contoured shape for the radial lever connector 100, to make it more conducive for a user to handle by placing their fingers into the recesses 101.

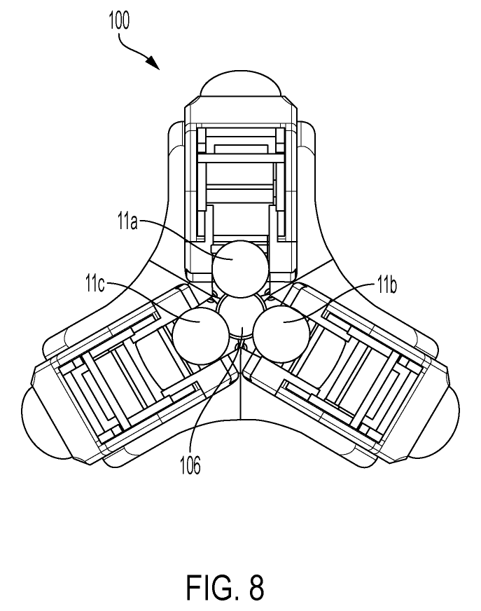

Each of the three wire channels 102 are configured to receive a wire conductor to be electrically connected to other wire conductors that are installed into the wire channels 102. The wire channels are symmetrically positioned around a central location, where inside the radial lever connector 100 a bus bridge conductor 106 is located at the central location. For example, FIG. 8 shows a rear-side view of the radial lever connector 100 where a back cover 107 has been taken off to show the internal components of the radial lever connector 100.

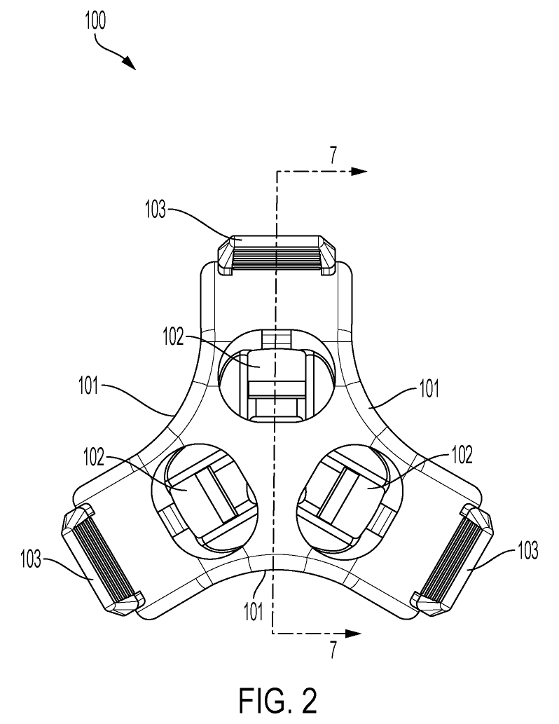

As shown in the front-side view of the radial lever connector 100 in FIG. 2, each wire channel 102 has a corresponding lever 103. When the lever 103 is in an open position, it results in the corresponding wire channel 102 to open for receiving a wire conductor. When the lever 103 is in a closed position, it results in the corresponding wire channel 102 to close by actuating a spring to clamp down the inserted wire conductor against the bus bridge conductor 106. FIGS. 1 and 2 show the radial lever connector 100 with the levers 103 in the closed position. Each lever 103 may be utilized independently.

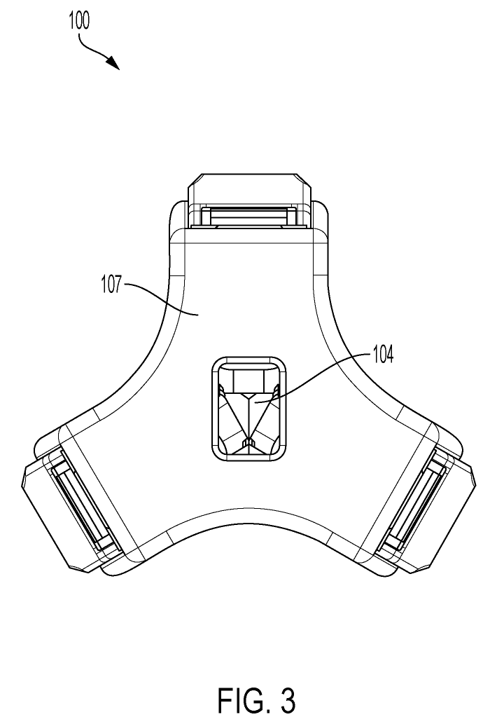

FIG. 3 is a rear-side view of the radial lever connector 100, where a rear opening 104 is positioned at a center location of a rear cover 107. The rear opening 104 may be a voltage test port for testing a voltage across the radial lever connector 100 for safety testing purposes.

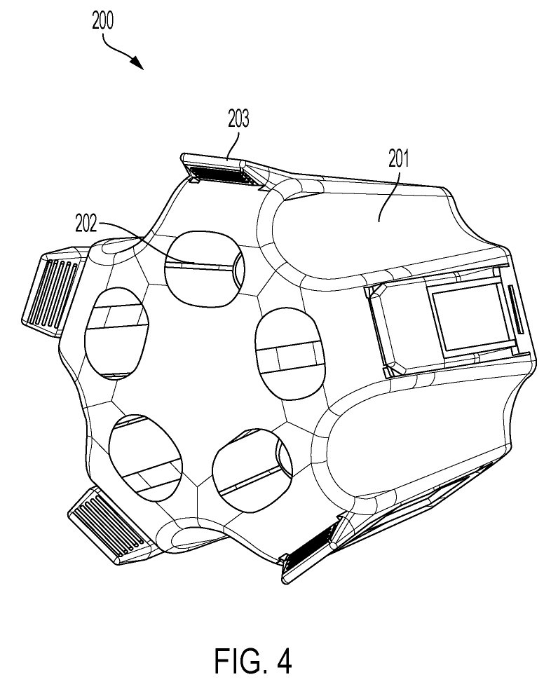

FIG. 4 shows a perspective view of a 5-wire radial lever connector 200 according to an alternative embodiment of this disclosure. The radial lever connector 200 includes a body housing that includes a number of recesses 201 corresponding to, for example, the number of wire channels 202 for receiving individual wire conductors. The recesses 201 provide a contoured shape for the radial lever connector 200, to make it more conducive for a user to handle by placing their fingers into the recesses 201.

Each of the five different wire channels 202 are configured to receive a wire conductor to be electrically connected to other wire conductors that are installed into the wire channels 202. The wire channels are symmetrically positioned around a central location, where inside the radial lever connector 200 a bus bridge conductor 106 is located at the central location.

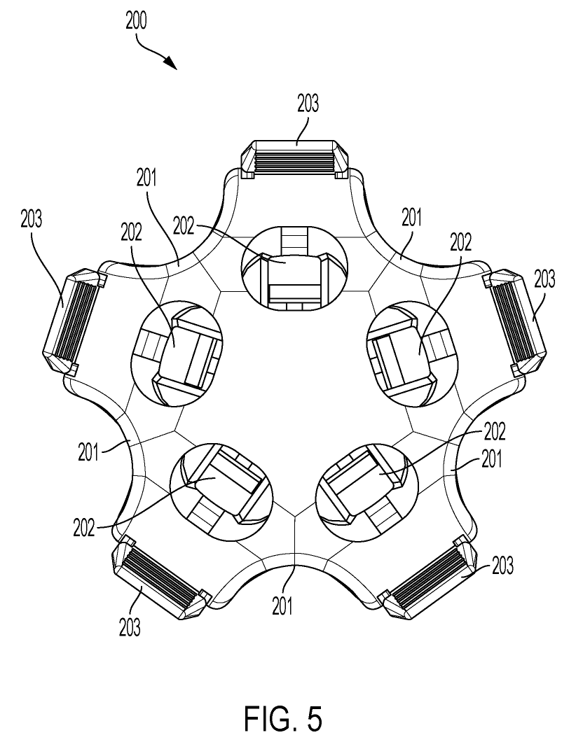

As shown in the front-side view of the radial lever connector 200 in FIG. 5, each wire channel 202 has a corresponding lever 203. When the lever 203 is in an open position, it results in the corresponding wire channel 202 to open for receiving a wire conductor. When the lever 203 is in a closed position, it results in the corresponding wire channel 202 to close by actuating a spring to clamp down the inserted wire conductor against the bus bridge conductor 106. FIGS. 4 and 5 show the radial lever connector 200 with the levers 203 in the closed position. Each lever 203 may be utilized independently.

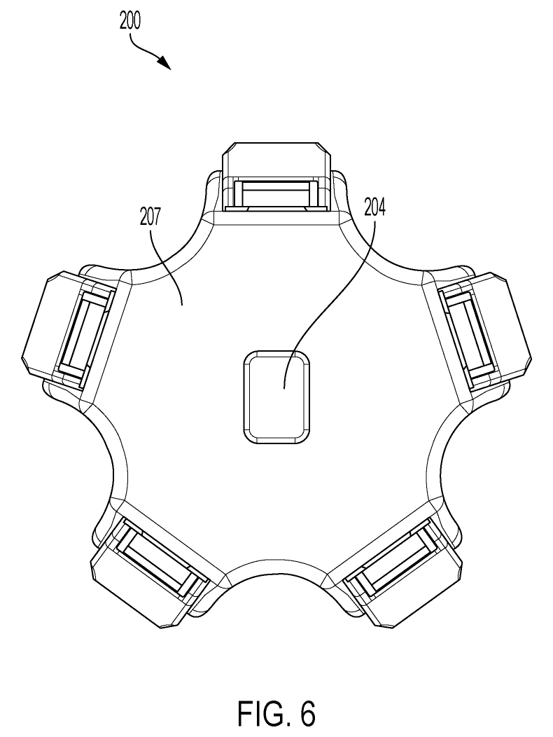

FIG. 6 is a rear-side view of the radial lever connector 200, where a rear opening 204 is positioned at a center location of a rear cover 207. The rear opening 204 may be a voltage test port for testing a voltage across the radial lever connector 200 for safety testing purposes.

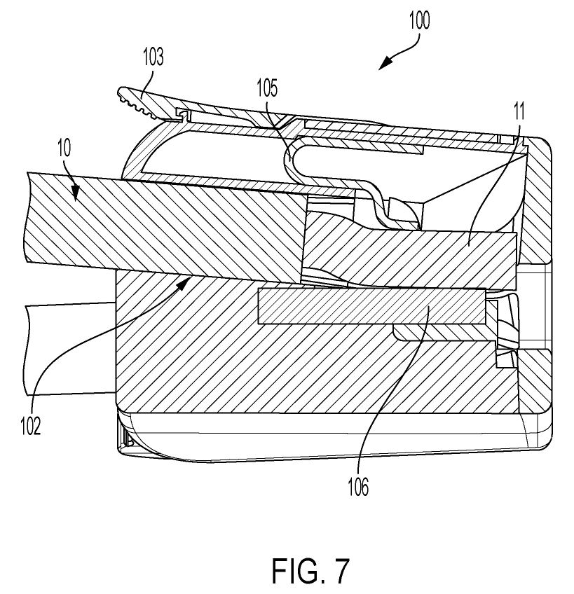

FIG. 7 shows a cross-sectional view of the radial lever connector 100 taken along the line 7-7 from FIG. 2. In FIG. 7, an exemplary conductor cable 10 is shown, where an insulation layer is stripped from an end of the conductor cable 10 to expose a wire conductor 11 that is inserted into the wire channel 102. The lever 103 is in the closed position so that a spring clamp 105 pushes against the wire conductor 11 so that the wire conductor 11 abuts against the bus bridge conductor 106. Other wire conductors 11 that are inserted into their own respective wire channels and abuts against the bus bridge conductor 106 will be electrically connected together with the wire conductor shown in FIG. 7.

Referring back to FIG. 8 showing a view of the internal components of the radial lever connector 100, the bus bridge conductor 106 is shown at the center position with wire conductors 11a, 11b, 11c radially surrounding and abutting against the bus bridge conductor 106. In this configuration, each of the wire conductors 11a, 11b, 11c are electrically connected to each other via their contact with the bus bridge conductor 106. In this configuration, the contact between the wire conductors 11a, 11b, 11c and the bus bridge conductor 106 is a larger surface area compared with the smaller point contacts found in linear design lever connectors that are currently known.

This arrangement allows for the bus bridge conductor 106 to be in the center of the wire conductors 11a, 11b, 11c inserted into the radial lever connector 100 rather than at the end of the linear lever connector design. This new central placement of the bus bridge conductor 106 is also a simplistic geometry from both a design and manufacturing sense and is extremely simplistic when compared to the intricate features on the stamped and bent sheet metal bus bars available on conventional linear lever connectors.

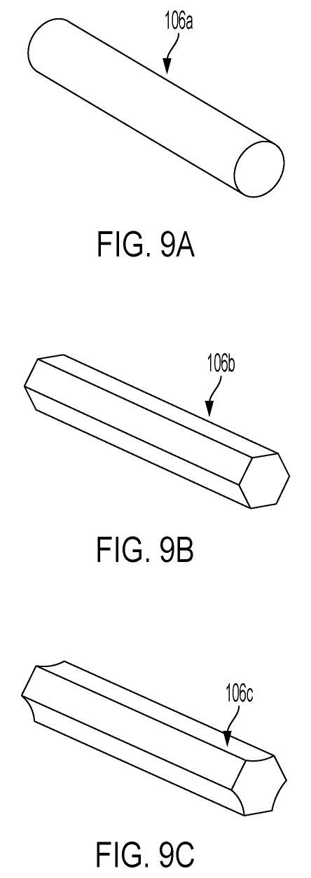

Another design benefit of the centrally located bus bridge conductor 106 design is that it will have the same, or nearly similar, cross-sectional area as the common wire conductor sizes that may be inserted into the radial lever connector 100 (e.g., typically 12 AWG wire conductors, but may be between 10 – 24 AWG). As shown in FIGS. 9A-9C, the bus bridge conductor 106a way be shaped to have a cross section of a circular shape (e.g., rod), the bus bridge conductor 106b way be shaped to have a cross section of a hexagonal prism, or the bus bridge conductor 106c way be shaped to have a cross section of a hexagonal prism with conductor recesses. Generally, a benefit of the longer rod/polygonal prism design for the bus bridge conductor 106 is that it is easily identifiable as to having the same or similar cross-sectional area as the conductors, as seen in FIGS. 9A-9C. This feature allows for peace of mind of the end user by having a quick visual check that the wire conductors are making contact with the bus bridge conductor, and also that the bus bridge conductor is of an equivalent size. Thus, for at least these reasons a concern for resistance heating while under load is alleviated.

For the rod shaped embodiment of the bus bridge conductor 106a shown in FIG. 9A, the contact surface area is small and most likely indeterminable since the contact can be considered a single tangential line of an interminable width, dependent on the material hardness of both the bus bridge and conduct along with the clamp force of the spring clamp 105. Solid and stranded wire conductors will behave differently when clamped to this design of the bus bridge conductor 106a, thus resulting in different contact surface areas. For example, a stranded wire conductor will have the tendency to bend and fan out to the curvature of the rod. This would increase the contact surface area between the conductor and bus bridge.

A solid wire conductor may flatten a little but will more likely only make contact on a single tangential line or curve but will more likely slip to one side or the other since we have two round surfaces mating in this scenario. It follows that this design for the bus bridge conductor 106a may work better with stranded wire conductors. Most likely solid wire conductors would see little improvement with the contact surface area over the conventional design by our competitors, although the solid wire conductors will be cheap and easy to manufacture, and can be purchased as off the shelf rolls since the size is a common wire gauge.

For the embodiments of the bus bridge conductor 106b having the hexagonal prism cross-section, a total surface area may be 0.01282 in² for the full length of the face. However less than half of the face may be exposed for contact with the wire conductor when installed in the housing of the radial lever connector 100, thus the available surface area may be considered 0.0054485 in². Solid and stranded types of wire conductors may behave differently when clamped to this bus bridge conductor 106b design, thus resulting in different contact surface areas. For example, a stranded wire conductor may have the tendency to flatten and fan out onto the contact surface. This would increase the contact surface area between the wire conductor and bus bridge conductor.

A solid wire conductor may flatten a little but will more likely only make contact on a single tangential line. It follows that this design for the bus bridge conductor 106b should work well with both wire conductor types. However, stranded wire conductors may likely see the most benefits from this design while solid conductors would see little improvement over the conventional design. This design for the bus bridge conductor 106b will also likely be cheap and easy to manufacture since the size is close to a common wire gauge, but the geometry is more complex compared to the simple rod design.

For the embodiments of the bus bridge conductor 106c having the hexagonal prism cross-section with the conductor recesses, a total surface area may be 0.01305 in² for the full length of the face. However less than half of the face may be exposed for contact with the wire conductor when installed in the housing of the radial lever connector 100, thus the available surface area may be considered 0.00554625 in². Therefore, this version of the bus bridge conductor 106c enjoys the largest surface area for wire conductor contact. Unlike the prior designs of the bus bridge conductor 106a, 106b, for the bus bridge conductor 106c the solid and stranded types of wire conductors will behave similarly when clamped to this bus bridge design.

For example, both the stranded and solid wire conductors will fit nicely into the concaved contact surface of the bus bridge conductor 106c. The bus bridge conductor 106c creates a cradle, with an increased surface area, to hold the wire conductor in place while the spring clamp 105 clamps down on the wire conductor. The bus bridge conductor 106c will most likely by cheap and easy to manufacture, since the size is close to a common wire gauge, but the geometry is the most complex of the proposed three designs. Of the three designs for the bus bridge conductor 106a, 106b, 106c described herein, the bus bridge conductor 106c with the hexagonal prism with conductor recesses cross section may yield the best results for reducing the likelihood of resistance heating due to it having the largest surface area.

As described above, existing spring clamps included in typical linear lever connectors have an issue of damaging wire conductors by physically gouging an indentation into the surface of the wire conductors. By physically gouging the wire conductors, this can lead to a reduced contact surface area between the wire conductor and a bus bar, which may result in an elevated operating temperature of the linear lever connectors, especially when under a sustained electrical load such as an electric heater, washing machine/dryer motor load, blower motor load on a forced air furnace, or other similar device, when compared to a traditional wire nut. In some cases, this could lead to a failure of the linear lever connector resulting in a melted/deformed connector housing, a short, or worse a fire, which are not desirable.

It follows that a novel contour spring design is disclosed that grips the wire conductor via a contoured gripper feature, that grabs around a perimeter and along a length of the wire conductor rather than destructively abut against the wire conductor at single point tangentially to the conductor surface, as is common for the traditional spring design. Therefore, the contour spring included in the radial lever connector is able to avoid gouging the wire conductor when the contour spring is activated to abut against the wire conductor during the clamping process when a lever is pushed into the closed position to lock the wire conductor within the radial lever connector.

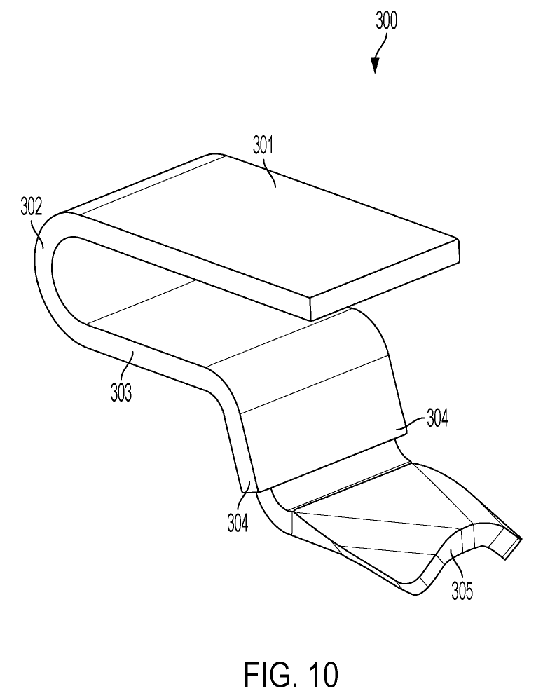

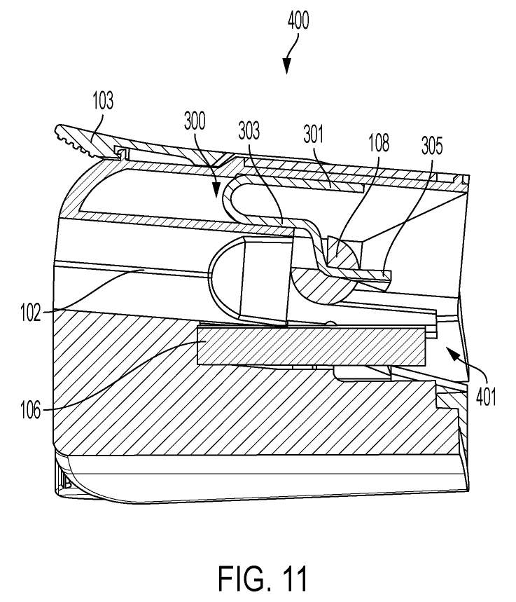

FIG. 10 shows a perspective view of a contoured clamping spring 300, according to an embodiment. The radial lever connector 400 shown in FIG. 11 may include the same features and/or components as the radial lever connector 100, with the exception being that the contoured clamping spring 300 is included to replace the more standard design of the spring clamp 105 included in the radial lever connector 100. Otherwise, the features and components of the radial lever connector 100 may remain the same. The contour shape of the contoured clamping spring 300 is better configured to provide a more natural fitting contact/grab along the contour of the wire conductor 11 that is inserted into the wire channel 102 of the radial lever connector 400.

The contoured clamping spring 300, as well as the spring clamp 105, may be made from a sheet metal. The overall width of the contour grip 305 may be configured to match a spring recess within the body housing of the radial lever connector 400, thus ensuring that the contoured clamping spring 300 is properly seated and centered relative to the wire channel 102 for properly griping and clamping the wire conductor 11 against the bus bridge conductor 106.

The contour spring includes a stationary leg 301 and a moving leg 303, where a spring bend 302 is included between the stationary leg 301 and the moving leg 303. The spring bend 302 functions as a torsion spring for the stationary leg 301 and the moving leg 303, which are pointed in the same direction.

As shown in the sectional view of FIG. 11, the stationary leg 301 is seated against the ceiling of the housing for the radial lever connector 400, keeping the contoured clamping spring 300 stationary and allowing the moving leg 303 to be manipulated by the lever’s cam lobes 108, for releasing and clamping the wire conductor 11 that is positioned within the wire channel 102. The moving leg 303 partially rests on the floor of the spring recess in the housing body of the radial lever connector 400, and the remainder is exposed to the wire channel 102 and the conductor contact area 401 where the contoured clamping spring 300 contacts the wire conductor 11. With this design, the moving leg 303 is given an unobstructed area to travel for the clamping function of the radial lever connector 400.

At the end of the moving leg 303 there is a finger to extend the reach downward towards where the bus bridge conductor 106 is and has some shoulders 304 for the lever’s cam lobes 108 to manipulate the contoured clamping spring 300 in a linear manner. This design allows for the largest range taking capability since the contoured clamping spring 300 does not need to be fully in the closed position for the lever 103 to return to its closed position. This design also allows for a push in function with solid wire conductors 11 due to the angle of the downward reaching finger. This is where the similarities between the design of the proposed contour clamp spring and the conventional clamp spring ends.

At the end of the downward reaching finger on the moving leg 303, past the shoulders 304, is the new innovative feature of the contour grip 305, which gives the contoured clamping spring 300 the capability to grab the wire conductor 11 around its contour and along the exposed length of the conductor in the wire conductor 11, rather than dig into the conductor via a flat blunt end and gouge the conductor as was the unwanted consequence of the flat ended clamp springs from other lever connector designs. The contour grip 305 feature achieves this by increasing the contact surface area between the conductor and the contoured clamping spring 300 via the “C” shaped contour grip 305 for gripping the exposed conductor in the wire conductor 11. Increasing this contact surface area directly increases the amount of friction the conduct experiences when clamped to hold the conductor in place and prevent it from being pulled out of the connector 400 when being subjected to normal movement related forces when being shoved into junction boxes and other enclosures.

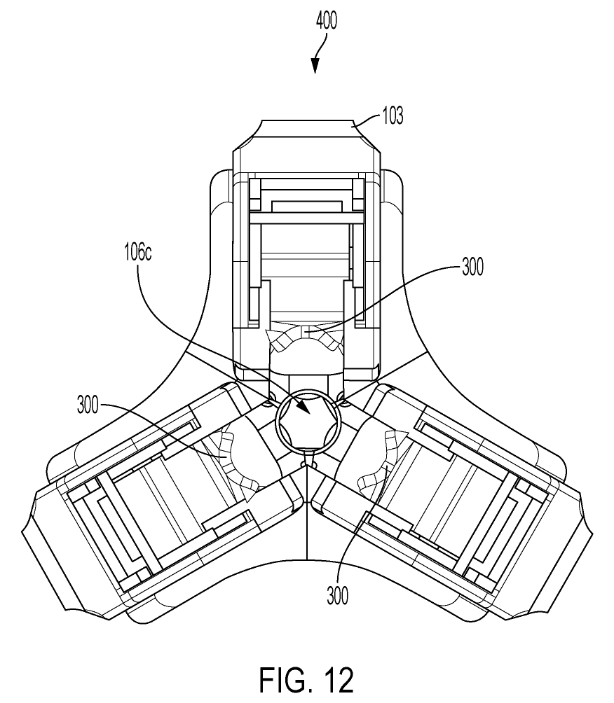

FIG. 12 shows a rear-side view looking into the connector 400 from a rear-side, where a rear cover has been removed to show the contoured clamping spring 300 in a disengaged position when the lever 103 is in the up position. In this disengaged position, the contoured clamping spring 300 is not yet abutting against a wire conductor 11 that may be inserted in the wire channels 102. Therefore, such wire conductor 11 may not be electrically contacting the bus bridge conductor 106c when the contoured clamping spring 300 is in the disengaged position.

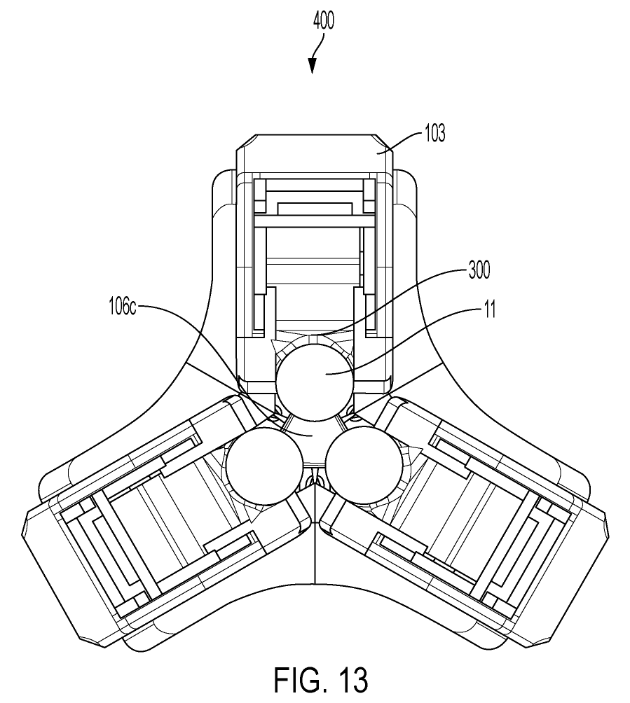

FIG. 13 shows the same rear-side view looking into the connector 400 when the rear cover has been removed as provided in FIG. 12. However, in FIG. 13 the contoured clamping spring 300 in an engaged position when the lever 103 is in the down position. In this engaged position, the contoured clamping spring 300 is abutting against a wire conductor 11 that is inserted in the wire channels 102. Therefore, such wire conductor 11 will be electrically contacting the bus bridge conductor 106c due to the contoured clamping spring 300 abutting and forcing the wire conductor 11 against the bus bridge conductor 106c.

In summary, this design of the contoured clamping spring 300 in the radial lever connector 400 utilizes a single moving leg design that increases the contact surface area between the spring and conductor. Thus, negating the unwanted consequence of a clamp spring digging into the exposed conductor to hold it in place and prevent movement and reducing the likelihood of gouging and other damage to the conductor that would have been the cause of failure in other lever connectors.

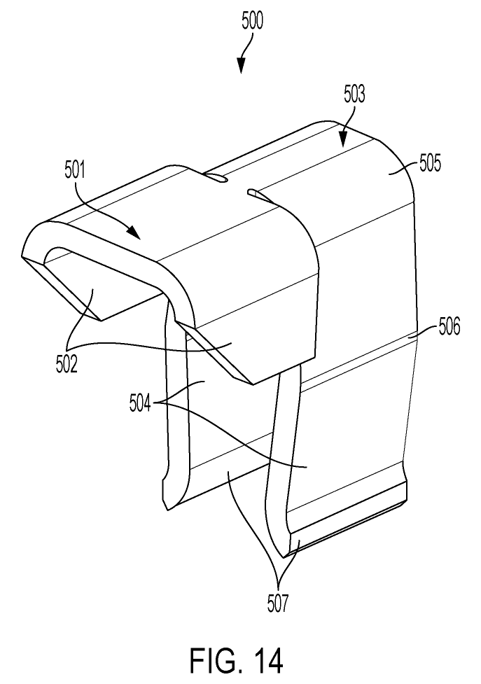

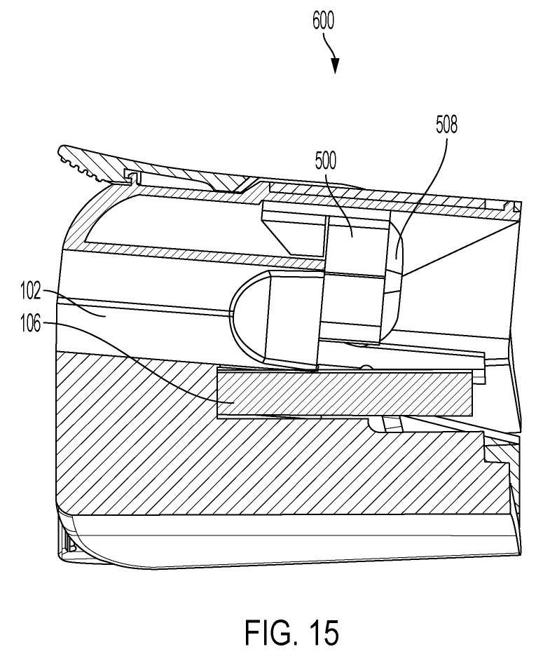

FIG. 14 shows a perspective view of a contoured leg springs 500 configured into a 2-leg design according to an alternative embodiment. The radial lever connector 600 shown in FIG. 15 may include the same, or similar, features and/or components as the radial lever connector 100, with the exception being that the contoured leg springs 500 is included to replace the more standard design of the spring clamp 105 included in the radial lever connector 100, and the cam lobe 508 has a revised design from the cam lobe 108 to accommodate the design of the contoured leg springs 500. Otherwise, the features and components of the radial lever connector 100 may remain the same. The contour shape of the contoured leg springs 500 is better configured to provide a more natural fitting contact/grab along the contour of the wire conductor 11 that is inserted into the wire channel 102 of the radial lever connector 600.

This innovative 2-leg design of the contoured leg springs 500 may resemble a pair of tweezers, with some additional features to fit in the housing body of the radial lever connectors described herein. The contoured leg springs 500 may be made from a sheet metal. The design is spilt into two parts: the Stationary End 501 and Spring End 503 to achieve the functionality of gripping the wire conductor 11. The stationary end 501 includes a pair of wings 502, and the spring end 503 includes a pair of legs 504.

The stationary end 501 is designed to fit into an opening of the spring recess so the contoured leg springs 500 may be mated to the housing like the vertical travel design. The wings 502 are features that allow this contoured leg springs 500 to fit into the housing body of the radial lever connector 600. The wings 502 may span the width of the opening to the spring recess and, when installed, the wings 502 may create an interference fit to hold the contoured leg springs 500 in place and centered about the wire channel 102, as the stationary leg 301 and overall width of the contoured clamping spring 300 did on the vertical travel spring design in the radial lever connector 400. So, when the contoured leg springs 500 is manipulated by the lever’s cam lobes 508 it remains in place to properly grab the wire conductor 11 for clamping.

Behind the stationary end 501 is the core of the contoured leg springs 500, which is the spring end 503, which has the tweezer-like legs 504 described earlier. The spring end 503 is connected to the stationary end 501 of the contoured leg springs 500 via the spring bends 505 at the top. The spring bends 505 allow for the legs 504 to bend inward towards the wire conductor 11 that are held between the legs 504. From those spring bends 505 extending downward are the tweezer like legs 504. These legs 504 span from the ceiling of the spring recess down towards the bus bridge conductor 106. Around halfway down the length of both legs 504 is a flex point 506. This flex point 506 feature gives the leg 504 a second joint to be directly manipulated by the lever’s cam lobes 508 for two purposes.

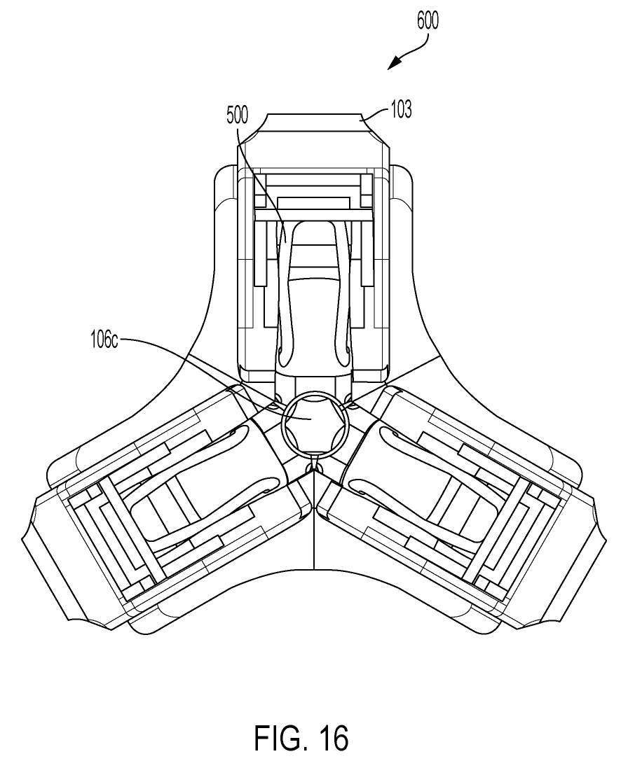

First, when the lever 103 is pulled up in the open position, the cam lobes 508 will have moved away from the spring legs 504, allowing the legs 504 to retract/pull away from the bus bridge conductor 106 into a disengaged position, due to the flex joint, allowing for the insertion of a wire conductor 11, as seen in FIG. 16. This travel design is critical for allowing the contoured leg springs 500 to accommodate differing conductor sizes.

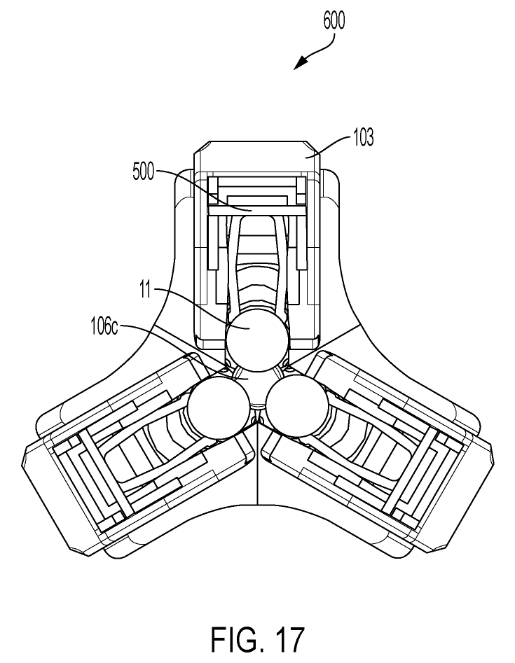

Second, when the lever 103 is in the closed position, the cam lobes 508 will force the joints in the flex point 506 to straighten out, thus increasing the linear length of the legs 504 relative to vertical axis that stretches from the ceiling of the spring recess to the bus bridge conductor 106, and conversely pushes down on to the wire conductor 11 to clamp it against the bus bridge conductor 106 into an engaged position, as seen in FIG. 17.

Finally, at the end of the spring legs are the contour grips 507, where these contour grips 507 are designed to increase the contact surface area between the contoured leg springs 500 and the exposed conductor of the wire conductor 11 to increase the amount of friction the conduct experiences when clamped to hold the exposed conductor in place and prevent the wire conductor 11 from being pulled out under normal movement of the into junction boxes and other enclosures. Thus, negating the need for a clamp spring to dig into the exposed conductor to hold it in place and prevent movement. The design of the contour grips 507 in this two-legged design includes curved fingers to grip the perimeter of the exposed conductor of the wire conductor 11, thus achieving the same goal of gripping the exposed conductor in a better manner.

So, rather than using a clamp spring that has linear travel along the vertical axis, meaning from the floor of the wire channel 102 to the ceiling of the spring recess, and thus resulting with the clamp spring obstructing the insertion path of the wire conductor 11 in the wire channel 102, the contoured leg springs 500 having the 2-leg design will have spring travel along the horizontal axis, meaning the legs of the contoured leg springs 500 will be parallel to the walls of the wire channel 102, i.e. along the wire insertion path. Thus, movement of the legs 504 will move towards the center of the wire channel 102 to pinch the wire conductor 11 between the legs 504 of the contoured leg springs 500 and the bus bridge conductor 106, when the legs 504 are manipulated by the cam lobes 508 as the lever 103 is moved to the closed position.

In summary, this design of the contoured leg springs 500 uses a simple and novel two leg design that increases the contact surface area between the contoured leg springs 500 and exposed conductor. Thus, negating the need for a clamp spring to dig into the conductor to hold it in place and prevent movement, and thus reducing the likelihood of gouging and other damage to the conductor that would have been the cause of failure in other lever connectors.

Furthermore, while the particular embodiments described herein have been shown and described, it will be obvious to those skilled in the art that changes and modifications may be made without departing from the teaching of the radial connector. The matter set forth in the foregoing description and accompanying drawings is offered by way of illustration only and not as limitation. The actual scope of the invention is intended to be defined in the following claims when viewed in their proper perspective.

What is claimed is:

1. A radial lever connector comprising:
a housing body comprising:
a first lever connector including a first lever and a first opening configured to receive a first conductor;
a second lever connector including a second lever and a second opening configured to receive a second conductor;
a third lever connector including a third lever and a third opening configured to receive a third conductor; and
a center portion housing a bus bridge conductor, wherein the first lever connector, the second lever connector, and the third lever are centered around the center portion.

2. The radial lever connector of claim 1, wherein the first opening, the second opening, and the third opening are included on a first side of the housing body.

3. The radial lever connector of claim 1, the housing body further comprising:
a first recess positioned between the first lever connector and the second lever connector;
a second recess positioned between the second lever connector and the third lever connector; and
a third recess positioned between the third lever connector and the first lever connector.

4. The radial lever connector of claim 1, the first lever connector further including a first spring clamp configured to clamp down the first conductor against the bus bridge conductor when the first lever is adjusted into a closed position.

5. The radial lever connector of claim 1, the second lever connector further including a second spring clamp configured to clamp down the second conductor against the bus bridge conductor when the second lever is adjusted into a closed position.

6. The radial lever connector of claim 1, the third lever connector further including a third spring clamp configured to clamp down the third conductor against the bus bridge conductor when the third lever is adjusted into a closed position.

7. The radial lever connector of claim 1, wherein the bus bridge conductor is configured in a cylindrical shape.

8. The radial lever connector of claim 1, wherein the bus bridge conductor is configured to have a polygon shaped cross-section including at least three sides.

9. The radial lever connector of claim 1, wherein the bus bridge conductor is configured to have a multi-sided cross-section including at least three recessed portions for sides.

10. The radial lever connector of claim 1, the first lever connector further including a first spring clamp comprising:
a stationary leg;
a moving leg; and
a contour grip configured to conform around at least a portion of the first conductor when the contour grip clamps down on the first conductor.

11. The radial lever connector of claim 10, wherein the moving leg is configured to interact with the first lever to bring the contour grip in contact with the first conductor when the first lever is in a down position and bring the moving leg off the first conductor when the first lever is in an opened position.

12. The radial lever connector of claim 1, the housing body further comprising a rear opening located on a second side of the housing body, the rear opening configured to provide access to the bus bridge conductor.

13. The radial lever connector of claim 1, wherein at least one of the first opening, the second opening, or the third opening is configured to receive the first conductor, the second conductor, or the third conductor that is sized to have a diameter that is 10 AWG or smaller.

14. The radial lever connector of claim 1, the first lever connector further including a contour spring comprising:
a pair of wings positioned at a stationary end;
a pair of legs including flex points and contour grips positioned at a far end of the legs, wherein the contour grips are configured to contact the first conductor at at least two contact points when the contour grip clamps down on the first conductor.

15. The radial lever connector of claim 14, the first lever further including a cam lobe configured to interact with the flex points to flex the pair of legs away from the first conductor when the first lever is in an opened position and allow the pair of legs to contract such that the contour grips contact the first conductor at at least two contact points when the first lever is in a closed position.
